(19) United States
(12) Patent Application Publication
(10) Pub. No.: US 2013/0158868 A1
(43) Pub. Date: Jun. 20, 2013

(54) RECURSIVE ROUTE PLANNING METHOD FOR ELECTRIC VEHICLE

(71) Applicants: Bo-Chiuan Chen, Changhua (TW); Yan-Jun Lai, Changhua (TW)

(72) Inventors: Bo-Chiuan Chen, Changhua (TW); Yan-Jun Lai, Changhua (TW)

(73) Assignee: AUTOMOTIVE RESEARCH & TESTING CENTER, Changhua (TW)

(21) Appl. No.: 13/325,931

(22) Filed: Dec. 14, 2011

(51) Int. Cl. G01C 21/00

(52) U.S. Cl. 701/527

(57) ABSTRACT

A recursive route planning method for a electric vehicle, the method comprising steps of: inputting a status condition, wherein the status condition has at least one starting point and at least one destination, mileages for remaining electric power and a route distance between the starting point and destination; searching all recharge stations between the starting point and destination covering the latitude and longitude; calculating distance between each recharge station to the starting point and the destination; removing recharge stations that do not meet a search condition; integrating a list of recharge stations and planning at least one optimum route for the electric vehicle; and executing the steps above when any status condition changes to retrieve a new driving route.

### FIELD OF THE INVENTION

The present invention relates to a recharge system of electric vehicles, and more particularly to a recursive route planning method for electric vehicle estimating remaining mileages for remaining electric power.

### BACKGROUND OF THE INVENTION

Today, more and more people pay attention to the environment and finding alternative energy sources has become an important issue. Although petroleum is still the main source of energy, the petroleum is gradually depleted and its related products causes serious environmental and ecological pollution. Therefore, it is an inevitable trend to develop alternative energy. Since the costs of developing new energy such as wind, solar, geothermal and other alternative energy sources are still high, the funding from government is necessary to support and continue the development of the alternative energy, so the result is limited due to insufficient funding. Conventionally, vehicles use gasoline combustion in the engine to generate power to move the vehicle forward, but a lot of exhaust gas causes air pollution and greenhouse effect. Thus, utilizing pollution-free energy becomes the current choice to replace gasoline. Recently, electric vehicles are promoted in line with trend of environmental awareness. No matter how the electric vehicle gets the electric power, it is undisputable that the electric vehicle can significantly reduce environmental pollution.

However, the electric vehicle is disadvantageous because the driving distance of the electric vehicle is determined by the electric power of the battery and the electric power is limited by the volume and weight of the battery. When the amount of electricity cannot be increased, the electric vehicle has to search recharge stations along the route to recharge. Also, the estimation of the amount of electricity does not linearly decrease as gasoline and dynamically measuring remaining electric power is not precise, so drivable mileage cannot be precisely calculated. The most annoying thing is that the electric vehicle runs out of battery while driving and the driver does not know where the recharge station is. Even though the drive knows the location of the recharge station, he/she does not know if the remaining electric power can still power the vehicle to the recharge station, which causes serious unsafe and uncomfortable feeling to the driver and prevent the driver from choosing the electric vehicle. The present invention would like to solve this problem.

### SUMMARY OF THE INVENTION

The technical problem the present invention wants to solve the problems stated above and provides a recursive route planning method for electric vehicles, the method including the steps of:

Step (a): inputting a status condition, wherein the status condition has at least one starting point and at least one destination, mileages for remaining electric power and a route distance between the starting point and destination;

Step (b): searching all recharge stations (from point A to point I) between the starting point and destination covering the latitude and longitude;

Step (c): calculating distance between each recharge station (A-I) to the starting point and the destination;

Step (d): removing recharge stations (A-I) that do not meet a search condition;

Step (e): integrating a list of recharge stations and planning at least one optimum route for the electric vehicle; and

Step (f): executing steps (a) to (e) when any status condition changes to retrieve a new driving route.

The main object of the present invention is to provide recharge stations (A-I) connected recursively to generate multiple route for the driver to choose to search for recharge stations (A-I), and to eliminate the driver's uncomfortable feeling about the recharge problem of the electric vehicle to achieve the goal of promoting the electric vehicles.

The second object of the present invention is to provide a rear end monitoring system that can timely update the information of the recharge stations and the driver, and can wirelessly update the information stored in the electric vehicle and timely report the status of the recharge stations in a predetermined area. The rear end monitoring system can also transmit the coordinate of the closest recharge station through GeoSMS to the driver's mobile device or a navigation system. So, the driver can effectively gather and update information of the recharge stations to improve the practicability.

### BRIEF DESCRIPTION OF THE DRAWINGS

FIG. 1 illustrates a flow chart of planning a driving route in the present invention.

FIG. 2 illustrates a flow chart of removing a recharge station using search condition in the present invention.

FIG. 3 illustrates a flow chart of modified method of estimating remaining mileage in the present invention.

FIG. 4 illustrates a schematic view of all recharge stations in a predetermined area in the present invention.

FIG. 5 illustrates a first schematic view of removing a recharge station using search condition in the present invention.

FIG. 6 illustrates a second schematic view of removing a recharge station using search condition in the present invention.

FIG. 7 illustrates a schematic view of updating a new driving route with a new starting point in the present invention.

FIG. 8 illustrates a flow chart of estimating the remaining electric power in the battery in the present invention.

FIG. 9 illustrates a flow chart of using the rear end monitoring system in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

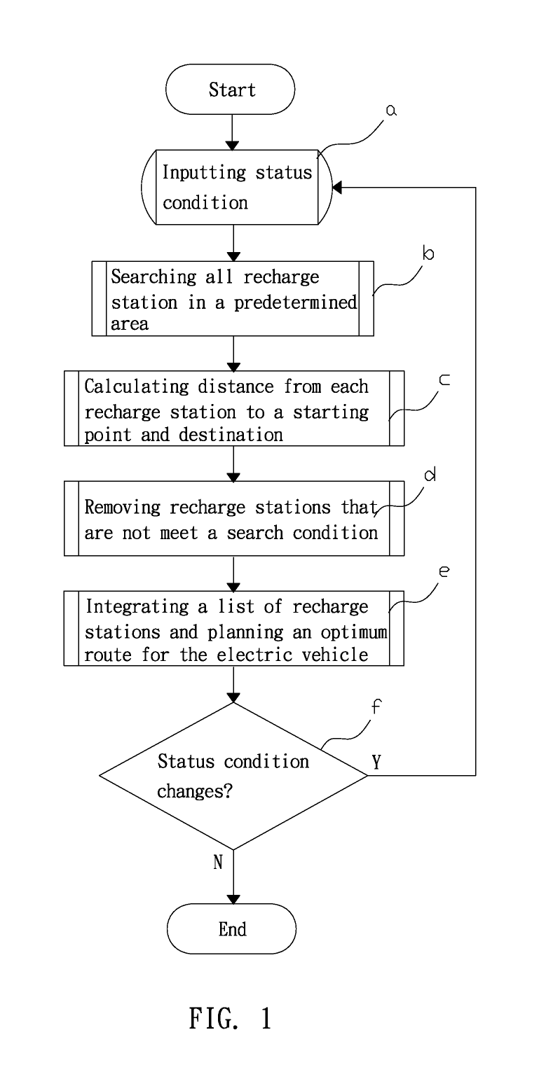

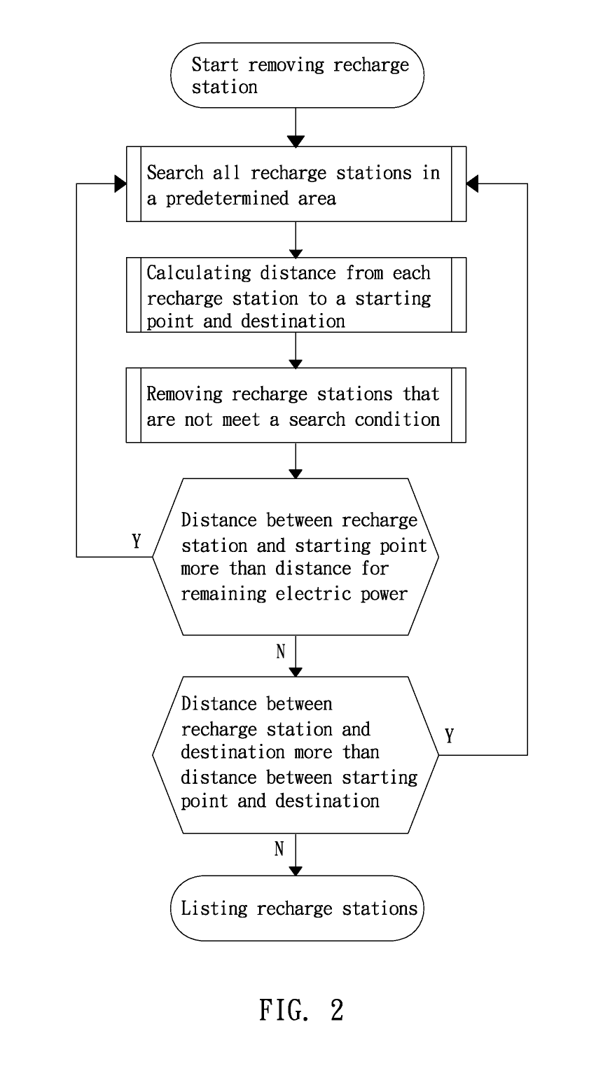

Referring to FIGS. 1 to 4, a method for planning recursive route for a electric vehicle includes:

Step (a): inputting a status condition, wherein the status condition has at least one starting point (11) and at least one destination (12), mileages for remaining electric power (13) and a route distance (14) between the starting point (11) and destination (12). The starting point (11), destination (12) and route distance (14) are changeable coordinates (according to the setting and position of the driver), and the starting point (11), destination (12) and the route distance (14) between the starting point (11) and the destination (12) are obtained by the calculation of Global Positioning System (GPS), and the mileages for remaining electric power (13) is obtained by a modified method of estimating remaining mileage (21);

Step (b): searching all recharge stations (from point A to point I) between the starting point (11) and destination (12) covering the latitude and longitude;

Step (c): calculating distance between each recharge station (A-I) to the starting point (11) and the destination (12);

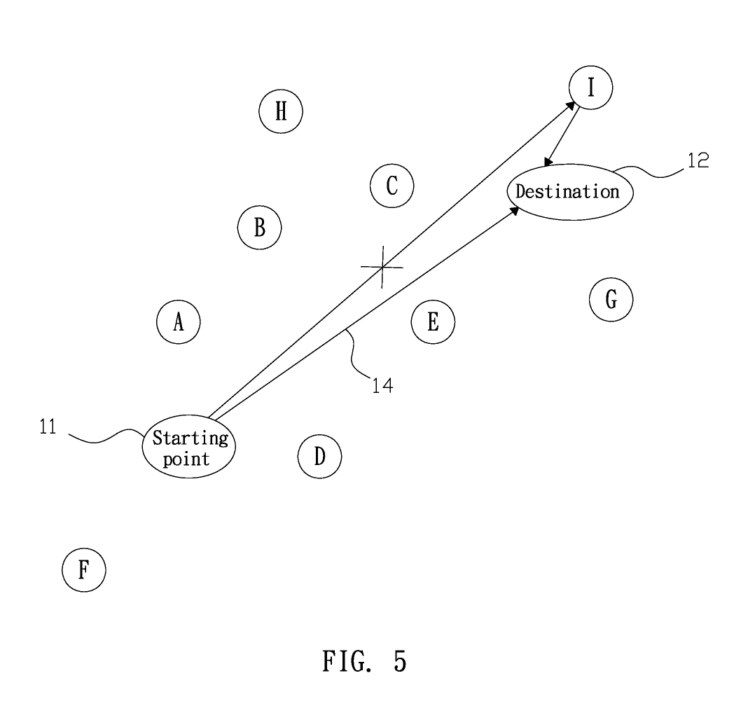

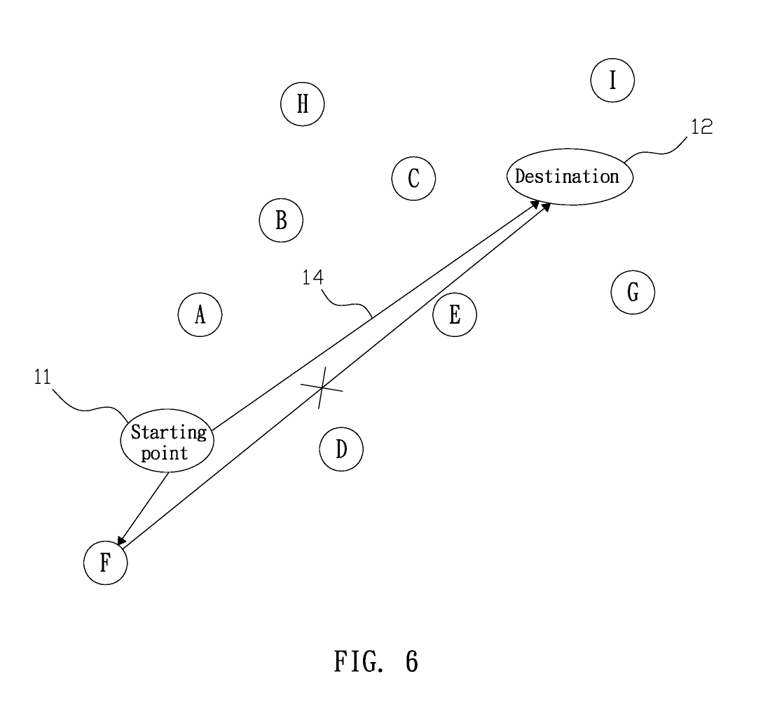

Step (d): removing recharge stations (A-I) that do not meet a search condition, wherein the search condition is that whether distance between the starting point (11) and the recharge stations (A-I) is longer than the mileages for remaining electric power (13). Further referring to FIG. 5, the distance between recharge station (I) and the starting point (11) is much longer than the distance between the starting point (11) and the destination (12), so that the mileages for remaining electric power (13) cannot support the electric vehicle to reach the recharge station (I) and the recharge station (I) is considered improper and out of the list in the search condition. Another search condition is that the distance between the recharge stations (A-I) and the destination (12) is longer than the distance between the starting point (11) and the destination (12), as shown in FIG. 6, where the distance between recharge station (F) and the destination (12) is longer than the starting point (11) and the destination (12), so that the mileages for remaining electric power (13) cannot support the electric vehicle from recharge station (F) to the destination (12) and the recharge station (F) is considered improper and out of the list in the search condition.

Step (e): integrating a list of recharge stations and planning at least one optimum route for the electric vehicle, and the optimum route can be prioritized by one of the following factors: shortest time, shortest route, minimum times of recharge, shortest time of recharge and driving direction; and

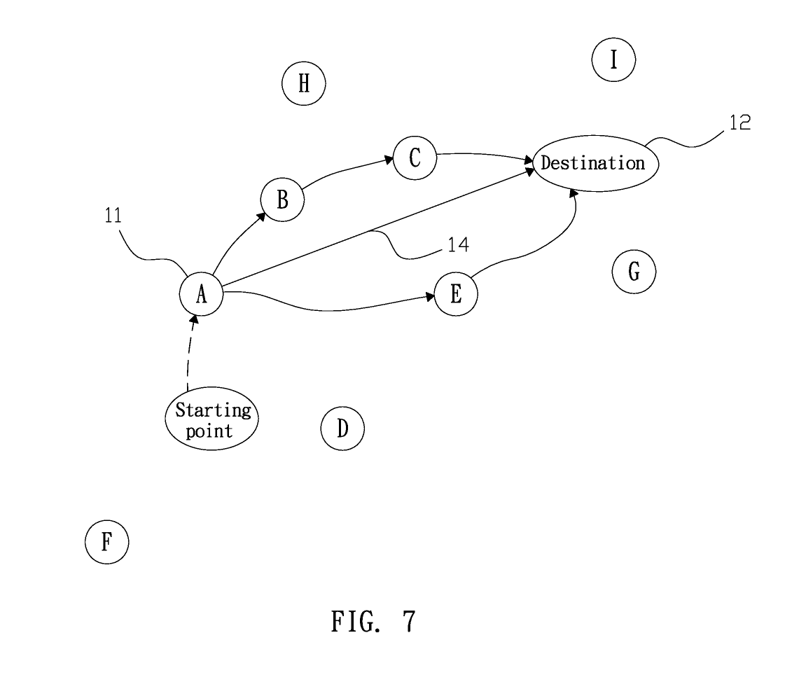

Step (f): executing steps (a) to (e) when any status condition changes to retrieve a new driving route. Referring to FIG. 7, when the electric vehicle drives to recharge station (A), the starting point (11) changes to the location of recharge station (A), and the route distance (14) is accordingly changed with the starting point (11), and step (a) to step (e) are repeated to generate a new optimum driving route with a new starting point (11). Likewise, if the destination (12) is changed or the mileages for remaining electric power (13) are changed due to road condition, car condition or battery conditions, the present invention can re-planning an optimum route. In other words, the recharge stations (A-I) are connected recursively to generate multiple route for the driver to choose to search for recharge stations (A-I), and to eliminate the driver's uncomfortable feeling about the recharge problem of the electric vehicle to achieve the goal of promoting the electric vehicles.

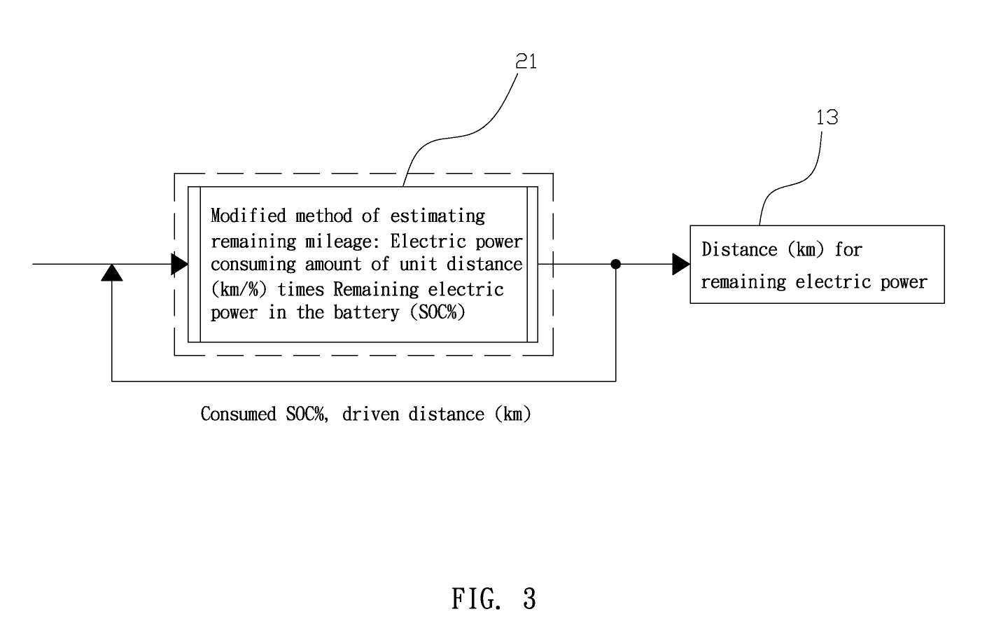

Furthermore, referring to FIG. 3, the modified method of estimating remaining mileage (21) is based on the remaining electric power in the battery (SOC %) and the distance already driven, and continues to modify as the remaining electric power in the battery (SOC %) decreases. The modified method of estimating remaining mileage (21) first includes dividing the driven distance (km) by the consumed electric power of the driven distance (%) to obtain an electric power consuming amount of unit distance (km/%), and finally multiplying the electric power consuming amount of unit distance (km/%) with the remaining electric power in the battery (SOC %) to obtain the mileages for remaining electric power (13) (km), wherein the mileages for remaining electric power (km) is the distance that can be driven using remaining electric power (SOC %). Table 1 shows the modified method of estimating remaining mileage (21) with real numbers:

TABLE 1

| | | | Electric power | |
|---|---|---|---|---|
| | SOC % | | consuming | |
| | sample | Driven | amount of | Driving distance for |
| | interval | distance | unit distance | remaining electric power |
| T₁ | 100% → 90% | 25 km | 2.5 km/% | 90% × 2.5 km/% = |
| | | | | 225 km |
| T₂ | 90% → 80% | 23 km | 2.3 km/% | 80% × 2.3 km/% = |
| | | | | 184 km |
| T₃ | 80% → 70% | 20 km | 2.0 km/% | 70% × 2.0 km/% = |
| | | | | 140 km |
| T₄ | 70% → 60% | 15 km | 1.5 km/% | 60% × 1.5 km/% = |
| | | | | 90 km |
| T₅ | 60% → 50% | 12 km | 1.2 km/% | 50% × 1.2 km/% = |
| | | | | 60 km |

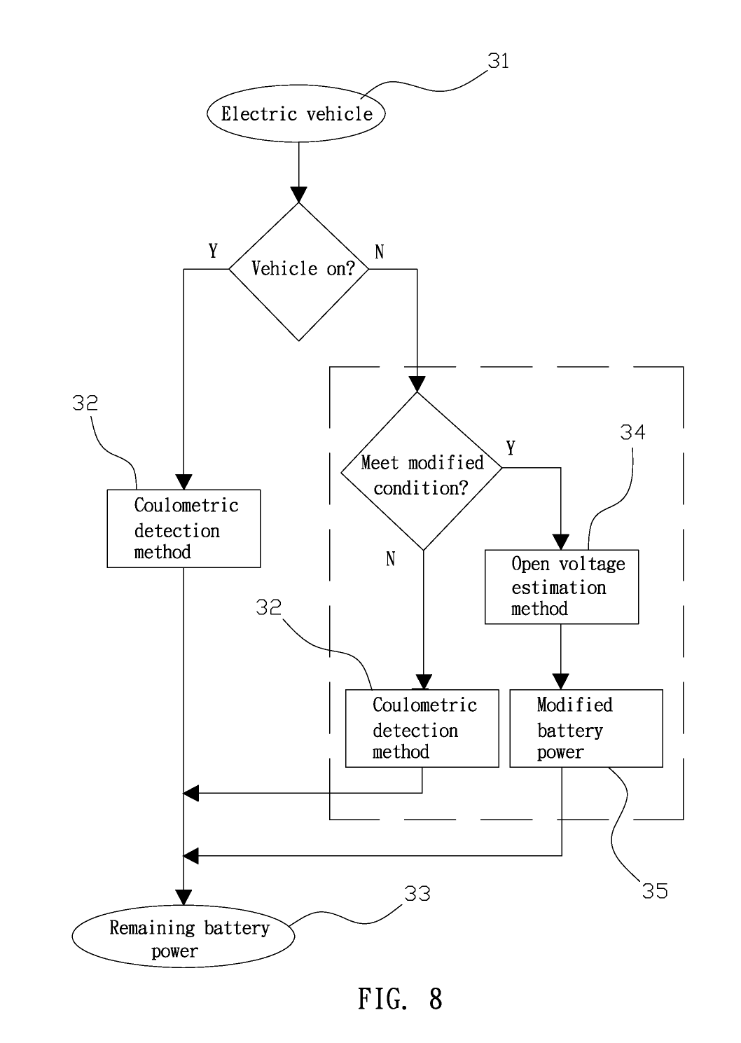

Referring to FIG. 8, when an electric vehicle (31) is on, the remaining electric power in the battery (33) can be obtained by coulometric detection method (32). When the vehicle is off, a modified electric power in the battery (35) is obtained by an open voltage estimation method (34), and the modified electric power in the battery (35) is used to modify the remaining electric power in the battery (33) when all conditions are meet. The first modified condition is when the battery is in the process of charging, the second modified condition is when the battery is rested for a certain period of time, and the third modified condition is the remaining electric power in the battery (33) is not equal to the modified electric power in the battery (35). Namely, using the open voltage estimation method (34) to modify coulometric detection method having accumulating errors to improve the precision of dynamic measurement of the coulometric detection method, so that the modified method of estimating remaining mileage (21) can obtain the mileages for remaining electric power (13) using the remaining electric power in the battery (33) to obtain a practical result of effectively planning a driving route.

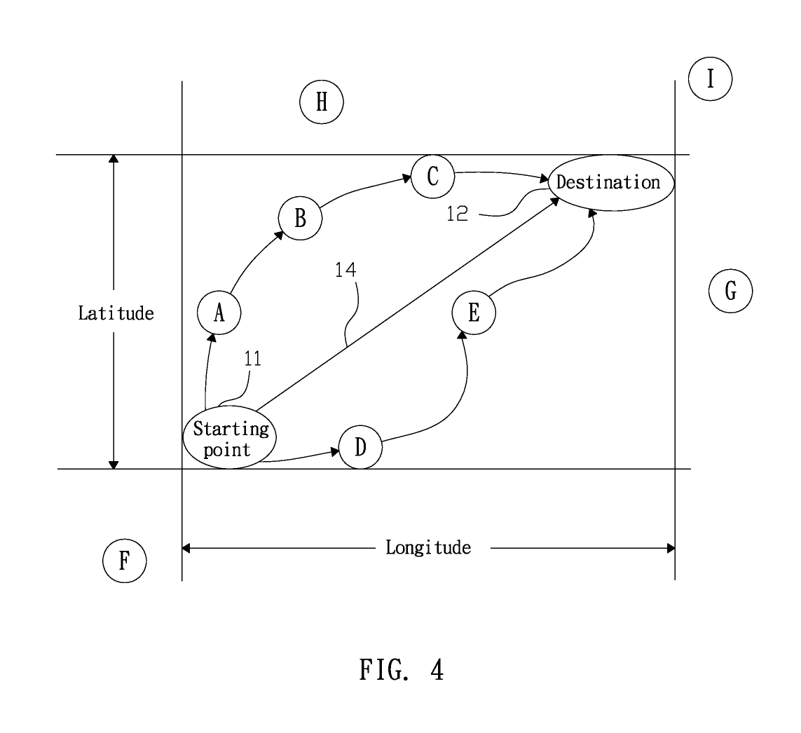

Referring to FIG. 4, the present invention further includes an alarm system (not shown). When the destination (12) is not set and the mileages for remaining electric power (13) (see FIG. 3) is smaller than the threshold of the alarm system, the alarm system actively provides a list of recharge stations (A-I) in the area nearby.

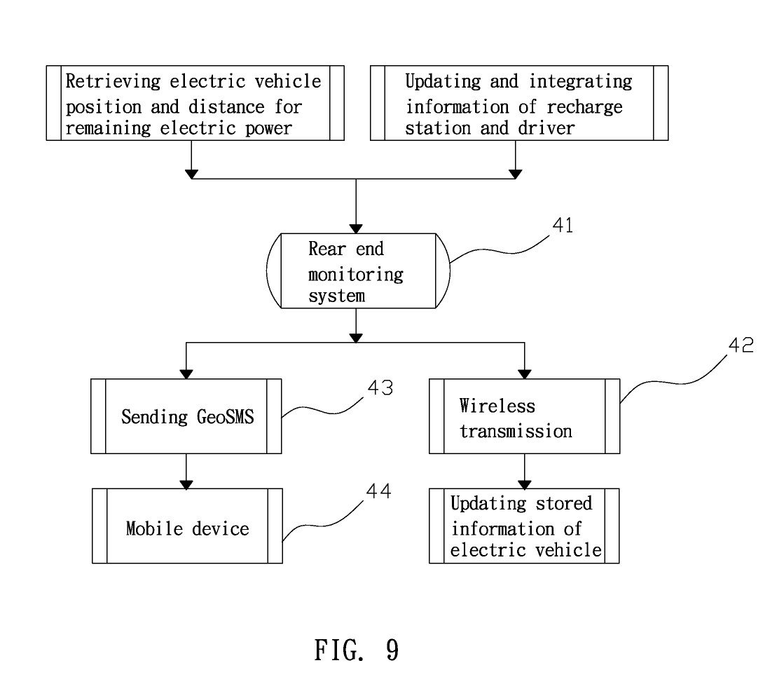

Referring to FIG. 9, the present invention further includes a rear end monitoring system (41). The rear end monitoring system (41) can timely update the information of the recharge stations and the driver, and can wirelessly (42) update the information stored in the electric vehicle and timely report the status of the recharge stations in a predetermined area. The rear end monitoring system (41) can retrieve the location of the vehicle and the mileages for remaining electric power (13) (see FIG. 3) from the driver's information, and receive the coordinate of the closest recharge station from the database of the recharge stations, and further transmit the coordinate of the closest recharge station through GeoSMS (43) to the driver's mobile device (44) or navigation system. The mobile device can be a smartphone or a PDA to effectively gather and update information of the recharge stations to improve the practicability.

Having described the invention by the description and illustrations above, it should be understood that these are exemplary of the invention and are not to be considered as limiting. Accordingly, the invention is not to be considered as limited by the foregoing description, but includes any equivalent.

1. A recursive route planning method for an electric vehicle, the method comprising steps of:
inputting a status condition, wherein the status condition has at least one starting point and at least one destination, mileages for remaining electric power and a route distance between the starting point and destination;
searching all recharge stations between the starting point and destination covering the latitude and longitude;
calculating distance between each recharge station to the starting point and to the destination;
removing recharge stations that do not meet a search condition, wherein said search condition includes whether the distance between the recharge station(s) and the destination is longer than the distance between the starting point and the destination;
integrating a list of recharge stations and planning at least one optimum route for the electric vehicle, wherein an optimum route is determined by one of the following factors: shortest time, shortest route, minimum times of recharge, shortest time of recharge and driving direction; and
executing the steps above when any status condition changes to retrieve a new driving route,
wherein the mileages for remaining electric power is obtained by modified method of estimating remaining mileage that is based on remaining electric power in the battery (SOC %) and distance already driven, and the modified method continues to modify when the remaining electric power in the battery (SOC %) decreases, and wherein the modified method of estimating remaining mileage comprising steps of dividing the driven distance (km) by consumed electric power of the driven distance (%) to obtain an electric power consuming amount of unit distance (km/%), and multiplying the electric power consuming amount of unit distance (km/%) with the remaining electric power in the battery (SOC %) to obtain the distance for remaining electric power (km).

2. The recursive route planning method of claim 1, wherein the distance between the starting point and the destination is obtained and calculated by Global Positioning System (GPS).

3. (canceled)

4. (canceled)

5. The recursive route planning method of claim 1, wherein when an electric vehicle is on, remaining electric power in a battery therein is obtained by coulometric detection method, and when the electric vehicle is off, a modified electric power in the battery is obtained by an open voltage estimation method, and the modified electric power in the battery is used to modify the remaining electric power in the battery when all conditions are meet, wherein a first modified condition is when the battery is in the process of charging, a second modified condition is when the battery is rested for a certain period of time, and a third modified condition is the remaining electric power in the battery is not equal to the modified electric power in the battery.

6. The recursive route planning method of claim 1, wherein the search condition is that whether distance between the starting point and the recharge stations is longer than the mileages for remaining electric power.

7. (canceled)

8. The recursive route planning method of claim 1, further comprising a step of providing an alarm system, wherein when the destination is not set and the mileages for remaining electric power is smaller than the threshold of the alarm system, the alarm system actively provides a list of recharge stations in the area nearby.

9. The recursive route planning method of claim 1, further comprising a step of providing a rear end monitoring system that is used to timely update the information of the recharge stations and the driver, and wirelessly update the information stored in the electric vehicle and timely report the status of the recharge stations in a predetermined area.

10. The recursive route planning method of claim 9, wherein the rear end monitoring system retrieves the location of the vehicle and the mileages for remaining electric power from the driver's information, and receive the coordinate of the closest recharge station from the database of the recharge stations, and further transmit the coordinate of the closest recharge station through GeoSMS to the driver's mobile device or navigation system.
